(19) United States
(12) Patent Application Publication
(10) Pub. No.: US 2009/0230125 A1
(43) Pub. Date: Sep. 17, 2009

(54) Technological development for carrying out cooking and chemical reaction, chemical synthesis, metalworking, metal cyrstallization, metal sintering and metallurgy by heating pottery with microwave for converting into far infrared or infrared wave radiation from pottery with increased heat efficiency

(76) Inventors: Buhie Kono, Kyoto (JP); Kazuhito Kono, Kyoto (JP); Takehiro Matsuse, Nagano (JP)

Correspondence Address: Kono Buhei, 313 Sashimonocho Ebisugawa agaru, Kyoto, 604-0903, JP

(21) Appl. No.: 11/920,958

(22) PCT Filed: May 29, 2006
(86) PCT No.: PCT/JP2006/311161

§ 371 Date: Nov. 23, 2007

(30) Foreign Application Priority Data
May 30, 2005 (JP) 2005-185673

(51) Int. Cl. H05B 6/64

(52) U.S. Cl. 219/680; 219/725; 219/756

(57) ABSTRACT

A method of heating a substance has not made much progress unlike rapid scientific developments. Although many studies have been made on the optimum heating temperature of a material, heating is not recognized in terms of the heat absorbing wavelength of a substance to be heated. Microwave heating provides a heating method by means of the friction heat of molecules, and microwave is separately absorbed to a magnetic element or the like and radiated by having its wavelength converted into a far infrared or infrared wave region can be controlled by a magnetic element's Curie temperature, a radiated wavelength region can be controlled within a specific temperature range, and heat energy increases when its density is increased. When, based on a principle of blackbody radiation, a magnetic element, magnetite, aluminum oxide, zirconia, zeolite, and the like applied to pottery is used microwave oven, high temperature can be obtained simply and in a short time without using an electric furnace thus enabling a wide application to chemical experiments. It has been learned that when this technology is used in microwave ovens used in homes across the country for cooking, delicious foods can be cooked simply and quickly even by elderly persons or children without using direct firing. Microwave heating using pottery started 15 years ago, but it has been left difficult to solve with little theoretical background. Magnetic element heating by microwave is beyond a classical physics idea region. Without being dependent on a classical physics theory uses a quantum mechanical effect that a magnetic element is irradiated with microwave and microwave is absorbed due to the spin resonance of magnetic element to radiate infrared rays. A combination of quantum mechanical theory by microwave irradiation to magnetic element and far infrared radiation effect by Planck's black body radiation is a key to this technology.

### BACKGROUND OF THE INVENTION

1. Field of the Invention

This invention is the method of cooking, heating, heating frozen foods, chemical reaction, chemical polymerization, chemical synthesis, metal processing, firing metal, and metallurgy by irradiating microwaves to the ceramic. This is the method of heating that we irradiate microwaves to the ceramic, microwaves are absorbed in the ceramic, transform to infrared and far-infrared wave and make the structure in which infrared and far-infrared waves radiate inside the ceramic. The heat efficiency rises up by rising the intensity of the infrared and far-infrared wave that radiates inside the ceramic under the optimal wavelength of infrared and far-infrared wave radiated in the ceramic and optimal temperature of the heated material in the ceramic. We can do quick cooking, chemical reaction, chemical synthesis, chemical dissolution, chemical polymerization, metal processing, metal crystallization, firing of the metal, metallurgy and rise the heat efficiency by the structure in which the intensity of radiated wavelength is raised up under the static temperature.

2. Description of the Related Art

The cooking method consisting of firing the Mn ferrite inside the ceramic and use the microwave oven was described in the Japan Patent 2005-71885 written by applicants. The material, especially food, has the optimal temperature and optimal wavelength of heating. We can raise the efficiency of heating by selecting the radiated wavelength of the infrared and far-infrared wave that coincides with the data of the wavelength. Up to the present, we did not cook under optimal wavelength and optimal temperature of the heated material. When cooking, we heat optimal temperature, by the experience of cook and housewife and controlled the intensity of fire. The materials have different optimal wavelengths of absorption. When we rise up the optimal intensity of wavelength under optimal temperature and heat material, the energy efficiency of the heat rises up. When we rise up the intensity of the wavelength of infrared and far-infrared wavelength, the intensity of the fire under direct heating increases and the intensity of wavelength rises up. When we rise up the intensity of the wavelength of infrared and far-infrared wavelength, the wavelength that exceeds the absorption wavelength of material is largely irradiated to the material; the material is burnt and loses the quality. The direct heating of the microwave oven is the method of heating of the friction of molecules. We rise up the power of microwave oven to heat the material in a short time. We heat and cook the material that is easy to burn in a long time under low temperature or scramble under low and even temperature inside the oven. In other methods, we heat under proportional temperature by reducing pressure. In either method, the cost of the facility is expensive and the loss of energy is large. The energy loss leads to an increase of the kitchen temperature and we need fans and air conditioner in the kitchen. Direct heating by microwave oven tends to raise the oven's power for short time cooking. Twenty years ago, the power of the microwave oven was mostly 0.5 kW. Recently, 0.7 kW and 1 kW microwave oven is prevailed. The absorption wavelength of cooking material is mostly 2.5 μm to 20 μm. The higher intensity of absorption wavelength is 3 μm to 12.5 μm. The optimal temperature of heating of the cooking material is 70° C. to 80° C. We need to rise up the intensity of infrared and far-infrared wavelength of absorption for fixing the taste under optimal temperature, and we radiate as less intensity of wavelength as possible that cannot be absorbed by the cooking material. The optimal temperature of cooking material of the wavelength of the absorption by blackbody radiation is 100° C. to 230° C. When we rise up the intensity of wavelength and radiate under this temperature region, we can cook effectively. When we rise up the temperature and rise up the intensity, the cooking material burns. When we rise up the intensity without rising the temperature, we do not need to worry about burning and we can cook in good thermal effect. The structure of microwave oven is that we irradiate the microwave in the domestic of the oven and the thermal efficiency is high compared to other heating facilities. We don't need to worry about the heat leaking. When we use microwave oven and heat proof glass for cooking, microwave is 100% transmitted and we cook and heat by molecular frictions.

In the heat poof ceramics that is used for cooking rice and potato, 20% to 30% of the microwave is absorbed, transformed to infrared and far-infrared wave, 70% to 80% of the microwave is transmitted and heat cooking material directly. The ceramic that uses open style carbon material is the same. The ceramic that uses closed style carbon material and glaze rises the temperature quickly, and the region of the needless wavelength is broad, then the cooking material is easily burnt. If there is few glaze in the carbon material, microwave is transmitted and heat cooking material by molecular friction. When we can transform the microwave to the infrared and far-infrared wave in 100% inside the ceramic and rise up the intensity of the optimal absorption wavelength of cooking material by blackbody radiation by home and industrial microwave oven and irradiate the cooking material, we can then rise up the thermal efficiency of heating cooking material.

When we make ceramics in spherical concave style and radiate the inside, the most effective cooking can be succeeded by blackbody radiation and quick cooking can be succeeded. The microwave is irradiated inside the oven but the wavelength is not transformed to the optimal wavelength of the cooking material by blackbody radiation, and is not used for cooking.

The microwave is reflected in the walls of the oven and heats the material by molecular friction. Direct heating of the microwave is the method of heating of the molecular frictions. The heating temperature is deviated by ion value of the molecules and fat and it is difficult to heat the cooking material by proportional temperature. When ion value exceeds 300 ppm, the microwave is concentrated to the surface portion that has high ion value, microwave does not transmit and only the surface is heated.

When there is a lot of fat on the surface of the cooking material, only the surface is heated, microwave does not transmit and the cooking material is burnt. When the frozen fish and meat are heated directly by microwave, proportional heating is hard. The chemical change by molecular frictions by microwave is indicated also. The infrared and far-infrared heating is the method of heating by vibrations of the molecules, the chemical change of the material is small and proportional heating can be succeeded in the cooking. We place the ceramic in the microwave oven, the microwave is absorbed, then we totally fire the magnetic material inside the ceramic, transform the microwave to infrared and far-infrared wave, rise the intensity of the radiated wavelength and we can cook in good thermal effect safely.

We make magnetic material in film, in the concave side inside the ceramic, and the convex side of the lid of the ceramic. We fire the magnetic material in the ceramic. When we heat said ceramic inside the microwave oven, the eddy current flows in the film of the magnetic material. The microwave that diffuses in the oven is absorbed in the magnetic material and the inside of the ceramic is heated. We choose the component of the magnetic material that has black color by blackbody radiation by the Curie temperature of the magnetic material for optimal temperature of the heating and fire inside the ceramic. We heat the ceramic inside the microwave oven, the microwave is then transformed to the infrared and far-infrared wave and radiate inside the ceramic in the similar wavelength of the blackbody radiation. The microwave in the microwave oven is absorbed in the magnetic field of the magnetic material that is fired inside the ceramic. The magnetic field increases, eddy current occurs, the diffusing microwave is absorbed effectively in the magnetic material in the ceramic and the heating efficiency rises. When the magnetic field of the magnetic material increases, the intensity of the infrared and far-infrared wavelength rises, the temperature of the ceramic reaches Curie point quickly and we can succeed sustainable heating. The highest heating temperature is decided by the Curie temperature of the magnetic material. We can sustain heating under highest temperatures. When the temperature and the optimal wavelength of the cooked material coincide, we can succeed heating stably. We choose Mn ferrite that has black color and has the structure of blackbody radiation and choose the optimal Curie point for heating. Then we can choose the magnetic material that has a high magnetization, strong durability and is good at processing.

The expensive facility was always required in nanoscale microwave chemical experiment. The high investment of facility costs prevented the experiment. It became hard for small companies and small colleges that had small grant of the research. The chemical experiments of the electric furnace were expensive and needed a long time to heat and reach the optimal temperature.

The ratio of processing impurity becomes large when the oven takes a long time to reach the setting temperature. The fast temperature rise is required for the stability of the process. The method of quick heating of the ceramic that takes advantage of microwave oven is good for small size experimental set up. The temperature rise is fast and investment cost is small. The method of heating by microwave oven is seen in a lot of experimental sites, but it cannot be heated by the advantage of principle of black body radiation. The method of heating when we insert thermocouple in microwave oven and measure the temperature exists. Heating by microwave irradiation is the heating method by molecular frictions. The chemical reaction is not clear by heating process or molecular reaction.

The processing of the nitric compound under the condition of the nitrogen gas and without oxygen in reduced pressure, nanoprocessing in ionization of rare gas and metal synthesis are seen in the chemical experiments in the heating by microwave. Reconfirmation of experiments always becomes a problem because reaction is influenced by heat or molecular friction. When we heat materials by deciding their structure according to the principle of the blackbody radiation, the temperature reaches more than 1000° C. within 5 or 10 minutes. The experiment of heating that is not dependent on the wavelength of microwave can be done. In blackbody radiation, the radiation of the 2000K is the range of the wavelength 0.3 μm to 80 μm. In this region of the wavelength, the highest intensity is the wavelength between 0.8 μm to 1.2 μm. The change of chemical compounds by the molecules friction in this wavelength is not reported academically and is regarded as the heating by molecule vibrations. The optimal wavelength for heating of chemical synthesis, chemical processing and chemical bonding is near the region of a melting point. The temperature of high intensity of blackbody radiation is similar to the region of the absorption wavelength of metal in metal synthesis and sintering. When the intensity of the radiation between the wavelength 0.8 μm to 1.2 μm and the region of melting point of the metal become high, high quality processing by heat can become possible. The processing and sintering of crystals by amplifying the intensity of the optimal wavelength of absorption has not been reported yet.

### DESCRIPTION OF THE INVENTION

We always need heating for processing food. In most cases, the method of heating was explained by the factor of experience. The optimal heating was not analyzed according to the optimal wavelength of the absorption in the cooking material.

For optimal heating in the cooking process, we need to know the optimal wavelength of absorption of food material under the temperature of cooking. When we irradiate an electromagnetic wave by amplifying the intensity of the optimal wavelength, we can get effective heating. The optimal wavelength of cooking is the region of infrared and far-infrared wavelength. The region of radiation wave length and the intensity become wide in high temperatures from the principle of blackbody radiation. If we irradiate the wavelength, except optimal absorption wavelength, for cooking food, the surface is burnt and the quality is deteriorated. The energy of irradiation is wasted.

For example, when we fry food and the oil reaches a high temperature, the surface of the food suddenly burns. The surface is burnt, but the inside of the food is cold. This is the example of this phenomena. The bunt part of the food often occurs by direct gas heating and inductive heating because they heat more than optimal heating temperature. In the same way, the food burns in microwave heating in a ceramic when we heat more than the optimal temperature and irradiate wavelength except optimal wavelength of absorption.

When the larger heat radiation is observed at the highest temperature, the material emits the highest intensity of the wavelength. The optimal temperature of cooking should be below 250° C. When we heat at a higher temperature than 250° C., the surface burns and the heat is not absorbed inside. As a result, the quality is deteriorated.

When optimal temperature and absorption wavelength coincide and the intensity of that wavelength is high, effective and tasty cooking can be done. The cooking goods consist of water, protein, fat and starch. The absorption wavelength depends on constitution of these. A lot of food contain a high ratio of water. When we irradiate food by amplifying the intensity of the wavelength 2.5 μm to 6.5 μm, that is, the absorption wavelength of water, the thermal efficiency becomes high. The absorption wavelength of food that has a lot of fat is 3.5 μm to 12 μm, and that of food which has a lot of starch is 3 μm to 10 μm. Vegetables contain a lot of water and so the wavelength of absorption is 2.5 μm to 10 μm.

A lot of kinds of food; beef, pork, chicken, wheat, rice, starch and vegetables have an optimal wavelength of absorption of 2.5 μm to 12 μm.

When the heating temperature surpasses 250° C. and becomes a high temperature, the wavelength of high intensity shifts from 2.5 μm to 1 μm.

This wavelength is not an optimal wavelength of cooking. Food burns.

The energy from high temperature is then wasted.

When we raise the intensity of the wavelength from 2.5 μm to 20 μm, the thermal efficiency becomes high. The method of raising the intensity of the wavelength is the following; we sinter Mn—Zn ferrite in one layer inside the total ceramic and we build the structure, in which microwaves are absorbed effectively. When we irradiate microwave to this ceramic inside the microwave oven, the inner of the ceramic is intensively heated. When we set the Curie temperature of ferrite at 200° C. to 250° C., which is the optimal temperature of cooking, the wavelength of the radiation inside the ceramic is the region of the infrared and far-infrared wavelength. To raise the intensity of this wavelength, we make the structure of ceramic in which eddy current runs the surface of the magnetic material and microwaves are absorbed effectively. The structure, height and length of the ceramic is decided by the size of the microwave oven. In other cases, we can raise the intensity of the infrared and far-infrared wave transformed from microwaves by raising the power of the magnetron of the microwave oven.

For processing food healthily, a temperature below 80° C., which does not damage the quality of protein, is the best. In other cases, vitamin is dissociated in high temperatures.

When we consider the heating method by the absorption wavelength of food and temperature, the optimal cooking temperature is below 80° C. In this temperature region, sterilization of food containing poisonous fungus can be possible. From the principle of the blackbody radiation, the intensity of the wavelength from 2.5 μm to 20 μm is large in the region of the temperature 100° C. to 250° C. When the temperature rises, the region of the wavelength becomes wide and so the waste of energy is larger. The cooking temperature should not surpass 80° C., which is the optimal temperature for cooking. When we raise the intensity of the wavelength from 2.5 μm to 20 μm in 100° C. to 250° C., the thermal efficiency rises and so quick cooking becomes possible.

The ceramic and pan are heated from the bottom in general cooking. The energy of the heat is spread in a room.

When we heat the microwave oven, microwaves become hot within a short period of time that shows microwaves spread and heat everywhere.

In order to raise the thermal efficiency and heat quickly while cooking, we build a structure that is similar to the optimal structure of the blackbody radiation. When we heat inside the microwave oven, thermal energy is absorbed inside the ceramic, and infrared and far-infrared waves are radiated inside the ceramic, therefore cooking can be done in high thermal efficiency. When we cook using this method, the temperature inside microwave oven is high, the temperature of side and upper is low. It shows a large difference compared to heating by heat proof glass. Temperatures from 100° C. to 600° C. are required for chemical synthesis and chemical reaction in electric furnace. Temperatures from 1000° C. to 1480° C. are required for nanoparticle synthesis and synthesis of nitride compound.

In order to rise this temperature by electric furnace of experimental use, we need at least 2 to 5 hours with a power 5 kW to 10 kW. A microwave oven is not expensive and can achieve a fast temperature rise with relatively low power. We attach the function of radiating heat inside the ceramic by the principle of black body radiation. We sinter magnetic material, magnetite and alumina inside the ceramic. In that case, the temperature of the ceramic with this function; volume of 2000 cc reaches 200° C. to 1500° C. in 5 to 10 minutes with a 0.5 kW microwave oven.

We can reduce the pressure of air and oxygen 20 to 30 mmHg in the ceramic. When we set up the hole for gas injection, we can inject rare gas and Argon gas. The ceramic has a heat proof range of 500° C. to 1800° C. We build the structure of the ceramic blackbody radiation, we paint the magnetic material, magnetite and alumina and we sinter those.

The function of temperature control is set at the Curie temperature when using the magnetic material. The temperatures of material such as SiC, alumina and magnetite rise about 1000° C. because of the vibration of molecules and atoms, resonance of spins and ponderomotive force. When the structure of the ceramic is similar to the structure of the blackbody radiation, the intensity of the waves becomes large.

When we inject Nitrogen gas under a high temperature 1000° C., the nitrogen compound is easily transformed into crystals. When we inject rare gas under the same conditions, plasma reaction is observed, and thin film processing and nano-processing can be gained. We paint and sinter the layer of Al, Ti, Si, Sn, Cr, Zn, Fe and their oxidized compound inside the ceramic.

The temperatures of the sintering natural zeolite, alumina, oxidized Titan, oxidized silicon, oxidized tin, oxidized chrome, magnetite and SrTiO₃ are 1050° C., 1400° C., 1300° C., 1400° C., 1200° C., 1400° C., 1150° C., 1000° C. and 1400° C. When we heat the material by microwaves under the similar conditions of blackbody radiation, the infrared and far-infrared are emitted inside the ceramic. The intensities and the peaks of the waves that are emitted in the ceramic that reaches 400° C. are deviated according to the materials. We can apply the above system to chemical processing and chemical synthesis.

The wavelength of the peak of emission by natural zeolite, alumina, oxidized titan, oxidized silicon, oxidized tin, oxidized chrome, oxidized zinc, and magnetite are respectively 2.5 μm to 8 μm and 13 μm to 20 μm, 7 μm to 12 μm, 5 μm to 12 μm, 5 μm to 8 μm, 8 μm to 14 μm, 8 μm to 15 μm, 5 μm to 15 μm, 5 μm to 14 μm. The peak of emission of SrTiO₃ is 5 μm to 13 μm. Oxidized zinc has the highest intensity of the emission wavelength of 5 μm to 10 μm, the second highest is SrTiO₃, the third is magnetite.

The regions and intensities of wavelength of emission are deviated according to the materials under the same temperatures.

We choose the material and sinter in the ceramic according to the intensity of the emission wavelength of Al, Ti, Si, Sn, Cr, Zn, Fe and their oxidized components, and we choose the materials which absorb the wavelength most. We insert these materials in the ceramic and we heat the ceramic by microwave. As a result of that, only certain wavelength regions are radiated and effective chemical synthesis and chemical reaction can be processed at the optimal wavelength. We control the power of the microwave for the chemical reaction and chemical synthesis under a stable temperature.

### BRIEF DESCRIPTION OF DRAWING

FIG. 1 the structure of the ceramic heated inside the microwave oven

a; the hole of the gas injection on the lid
b; the hole of inserting thermometer from the lid
c; hole that is used for observing inside the ceramic

### DESCRIPTION OF INVENTION AND PREFERRED EMBODIMENTS

We paint Mn—Zn ferrite or magnetic materials inside the ceramic, lid in one layer and sinter with glaze of the same color. Inside the ceramic, the color becomes totally black. When we heat the ceramic by microwave, far-infrared and infrared wave are emitted inside the ceramic from the principle of blackbody radiation.

According to Planck's law of blackbody radiation, the intensity of the emission of infrared and far-infrared waves is 2.613×10³W/m² under a temperature of 200° C. The wavelength of the highest intensity is 6.126 μm.

The food heating temperature which does not change the quality of protein is 80° C. The intensity of infrared wave emission is 8.219×10²W/m² under an temperature 80° C. The wavelength of highest emission is 8.206 μm.

When we heat water at 80° C., the optimal wavelength of absorption is deviated from wavelength 2.5 μm to 6.5 μm a little. The optimal wavelength of water absorption is the same as wavelength which is emitted at 180° C. to 250° C. in blackbody radiation. This region becomes the most efficient heating.

The infrared and far-infrared waves are emitted from wavelength transformation from microwaves inside the ceramic by using a microwave oven.

The following equations (1) to (4) show the efficiency of wavelength transformation from microwave and their thermal effect using a ceramic with magnetic material Mn—Zn ferrite is more efficient than direct microwave irradiation. The microwave is absorbed in the Mn—Zn ferrite, the atoms which have magnetization are transited, the energy of microwave is amplified and Mn—Zn ferrite emits infrared and far-infrared waves. The efficiency of heating with the same power is explained in the following equations.

The loss of energy in which microwaves are absorbed in magnetic material is shown in equation (1).

$${P}_{L} = \frac{{B}_{rf}^{2} V}{8 π} \frac{ω}{Q} \qquad ( 1 )$$

P_{L}; loss of energy, B_{rf}; magnetic field of microwave, V; volume of vessel, ω; frequency of microwave, Q; loss factor of microwave

Equation (2) shows that the energy of infrared and far-infrared waves are emitted when microwaves are absorbed in the magnetic material.

$$P = {( \frac{2 π μ {B}_{rf}}{h} )}^{2} \frac{1}{2 πΔ ω} h ω n \qquad ( 2 )$$

P; the emitted energy from the absorption, μ; magnetic moment, B_{r f}; magnetic field of microwave, h; Planck constant, Δω; the deviation of frequency between microwave absorption and infrared emission ω; frequency of infrared emission, n; number of magnetic atoms transited, Equation (1) shows the energy of microwave absorption and the equation (2) shows the energy of infrared wave emission. The ratio of these shows the deviation of energy.

When we divide equation (2) by (1), we get equation (3).

$$P / {P}_{L} = 16 π Q \frac{{μ}^{2} n}{Δ ω h V} \qquad ( 3 )$$

magnetic moment; μ=3.0×10⁻²³ (J/T) (magnetic moment of Mn) Planck constant; h=6.6×10⁻³⁴ (J s)

When we substitute the number of magnetic moments and Planck constant in equation (3) and the frequency of microwave 10⁹ Hz is then transformed to a frequency of infrared wave 10¹⁴ Hz and the number of magnetic atoms transits is 2×10⁸/m², we can calculate P/P_{L} is 10 to 100. The energy of emission is amplified 10 to 100 times from by the energy of absorption.

The thermal energy increases by microwave transformation in the ceramic.

The frequency of emission of electromagnetic wave and transited magnetic field are shown in the following equation (4).

μΔB=hΔω/2π (4)

ΔB; the transited magnetic field by microwave absorption and emission of infrared waves,
the frequency of microwaves is 10⁹ Hz, the frequency of the infrared wave is 10¹⁴ Hz, wavelength 3 μm, and the infrared wave is emitted in the 10⁻¹ gauss transited magnetic field.

The intensity of electromagnetic field emission from the absorption of microwave is bigger as the magnetic moment u is bigger. We choose number of spins of 3; Mn that is used in Mn—Zn ferrite.

The intensity of far-infrared waves that are emitted inside the ceramic from microwave absorption in the magnetic material is calculated in equation (2), that is 3.675×10⁴W/m². The intensity of far-infrared wave emission in blackbody radiation at a temperature of 80° C. is 8.219×10²W/m² and infrared emission by blackbody radiation at 200° C. is 2.613×10³W/m². The infrared emission inside the ceramic from microwave absorption in the magnetic material is bigger than the infrared emission by blackbody radiation.

When we paint one layer of magnetic material Mn—Zn ferrite inside the ceramic and we heat by microwave, infrared emission by blackbody radiation and infrared emission by the transition of Mn—Zn ferrite atoms by microwave irradiation occur.

The optimal wavelength of infrared and far-infrared wave absorption exists in food. The optimal wavelength of absorption of food is in the region, 2.5 μm to 20 μm. When we increase the intensity of emission of this wavelength, effective heating of high thermal efficiency can be done. I satisfy the condition of inside the ceramic blackbody radiation and I showed the radiation under blackbody radiation at 80° C. and 200° C. The infrared emission from the atomic transition of the magnetic material of microwave absorption in magnetic material becomes 10 to 100 times larger than the emission of normal blackbody radiation from equation (3). Infrared and far-infrared emission within an optimal food absorption wavelength range is 10 times to 100 times larger than the intensity of normal blackbody radiation because of atomic transition of the magnetic material from microwave absorption in the magnetic material. The energy of infrared emission is amplified by the input microwave energy.

Chemical bonding and chemical synthesis can be processed between more than two materials. The thermal transportation occurs between different molecules. The optimal infrared and far-infrared absorption wavelength exists in any material. The materials have similar optimal absorption wavelength for synthesis, bonding, dissolution and polymerization. We heat from outside the ceramic for promoting chemical synthesis and controlling temperature.

The optimal temperature exists in chemical synthesis, and chemical synthesis, bonding, dissolution and polymerization can be processed at that temperature. The optimal wavelength for processing exists in chemical reaction in the temperature until boiling point. It is important for chemical reaction and synthesis to reach the optimal reaction temperature. The quality and purity of the material is better for shorter reaction time and it is also convenient economically.

The optimal heating temperature of metals is melting point of metal or its near temperature in metal processing, metallurgy and sintering. The optimal wavelength of absorption of metal in melting point of metal is 0.5 μm to 1.5 μm. When we raise the intensity of the optimal absorption wavelength and sinter and process the metal by raising temperature until we reach the melting point, high purity and economical processing can be succeeded.

When we irradiate microwaves to the magnetic material such as magnetite, SiC, zirconia and alumina which are painted and sintered inside the ceramic, the temperature of the magnetic material rises to the Curie temperature and SiC, zirconia and alumina reach a temperature of 1000° C. to 1500° C.

Then we select materials such as magnetic material SiC, zirconia, alumina depending on the chemical material for processing and metal for sintering. We paint and sinter those in the ceramic and heat by microwave, the microwave is absorbed by the vibrations in the molecules and atoms, changing permeability and dipole momentum by quantum mechanical transitions, the energy of microwave is amplified and the temperature rises to a high temperature by ponderomotive force.

The absorption energy of microwaves is amplified by the energy loss of the microwaves according to vibrations of atoms and molecules in the materials. The microwave energy of absorption and energy loss under the same power are explained in the following equations.

$${P}_{L}^{′} = \frac{{E}^{2} V}{8 π} \frac{ω}{Q} \qquad ( 5 )$$

P′_{L}; loss energy of absorption, E; electric field of microwave V; volume of the vessel, ω; frequency of microwave Q; loss factor of microwave

The amplified energy of microwave absorption by the vibration of the molecules and atoms in the material is shown in equation (6).

$${P}^{′} = 4 {π}^{2} \frac{{ρ}^{2}}{{h}^{2}} {E}^{2} ( h {ω}_{0} n ) \qquad ( 6 )$$

P′; the amplified energy by the resonance of absorption, ρ; polarization of the material, h; Planck constant, E; electric field of microwave ω₀); resonance frequency of microwave, n; number of atoms and molecules transited by the resonance

We divide equation (6) by (5) and compare the values, the result is the following.

$${P}^{′} / {P}_{L}^{′} = \frac{32 {π}^{2} ρ Vn}{hQ} \qquad ( 7 )$$

The greater the polarization and the number of atoms are, the greater the value of P′/P′_{L}. The value of P′/P′_{L} lies between 100 to 1000. The absorption energy of microwave by the vibrations of atoms and molecules in the material is amplified. According to this energy, the phenomena of high temperature rise of the magnetic material such as magnetite, zirconia and alumina is explained.

Microwaves are absorbed in the magnetic material such as magnetite, zirconia and alumina by the vibrations of atoms and molecules, and infrared and far-infrared are emitted. The energy of infrared and far-infrared is amplified by the input energy of microwaves. The optimal infrared and far-infrared wavelength for chemical synthesis, metallurgy and sintering is amplified and is used for processing these. We process particles of the magnetic material such as magnetite, SiC, zirconia, alumina which have a size of 5 μm to 10 μm, and sinter them inside the ceramic as one layer with a thickness of about 20 μm.

We irradiate microwaves to the ceramic, microwaves are transformed to infrared and far-infrared wave and infrared and far-infrared waves are emitted inside the ceramic. The food, chemical material and material, which are synthesized and sintered, absorb the infrared and far-infrared waves. The absorption energy of infrared is transformed to thermal energy by the vibrations of atoms and molecules and the temperature of the material and food rises.

When we use the Helmholtz free energy and the amplification of infrared and far-infrared wave energy becomes 10 to 100, the temperature rise is 3 times to less than 10 times. When the amplification of the energy of infrared and far-infrared wave increases 100 times to 1000 times, the temperature rise is 10 times to less than 30 times greater.

We paint and sinter the magnetic material which has a Curie point 200° C. in the ceramic piece with a 5 cm×5 cm and 4 mm thickness. We measure the wavelength and intensity of infrared and far-infrared waves at 200° C. The measurement is done with spectroscopy IR-435. The range of measurement is 2.5 μm to 25 μm but the peak of high intensity ranges from 5.5 μm to 6.5 μm.

The peak of infrared emission by microwave heating is also considered within this region. The infrared emission in this range is amplified by microwave heating, and the thermal efficiency increases.

We make a ceramic; vessel and lid the structure of blackbody radiation. We process the magnetic material for sintering three kinds of Mn—Zn ferrites Curie points at 200° C., 150° C. and 250° C. We compare these three ferrites' qualities by experiments. The volume of the ceramic is 750 cc, length 17 cm and height 8.5 cm. We process the particles of the 10 μm magnetic material, which has a layer thickness of 20 μm in the ceramic.

We sinter the ceramic at 1250° C. We use a microwave oven first with a power 0.5 kW and then 0.7 kW.

We proceed to the following experiments for proving thermal efficiency.

We compare the thermal efficiency of the following items; quarts glass vessel, black color rice cooker which is made of heat resistant ceramic, and ceramics sintered with three different magnetic materials. We compare the cooking times for rice.

We cook by these items water 200 g and rice 260 cc and check the time and taste. We use 0.5 kW microwave oven, and spend time until 96° C., near boiling point for completing cooking.

| | |
|---|---|
| Quartz glass | 360 seconds |
| Rice cooker | 360 seconds |

Ceramic with magnetic materials

| | |
|---|---|
| Curie point 200° C. | 340 seconds |
| Curie point 150° C. | 355 seconds |
| Curie point 250° C. | 336 seconds |

The time deviation until boiling is 10 seconds to 24 seconds.

After boiling, we switch the power to half, heat during 5 minutes and check the conditions.

The boiling quality is not good enough and the sticky taste exists in rice cooking when using quartz glass. The condition of cooking in using ceramic rice cooker is improved. The conditions of using the ceramics with magnetic materials are the same and rice is sticky a little but we can taste good.

When we leave all the cooking devices for three minutes covering with lids, the condition of cooking using quarts glass is not good eating condition, when using rice cooker rice has a sticky taste a little bit, but when of using ceramic with magnetic materials rice is good condition for eating. These deviations of conditions are caused by the infrared and far-infrared emission of the ceramics using magnetic materials in the heating. The time of cooking in rice cooker is faster than that of using quarts glass, but it is not deviated so much. It takes 1,440 seconds that is 24 minutes for cooking rice for eating by microwave irradiation using the rice cooker and quarts glass. It takes 820 seconds, 835 seconds, 816 seconds when using ceramics with magnetic materials Curie point of respectively 200° C., 150° C., 250° C. We can shorten cooking times by 605 seconds to 624 seconds when using ceramics with magnetic materials.

The larger the Curie points of magnetic materials become, the faster until boiling point it reaches. The time deviations appear according to the Curie point of the magnetic materials, but the times until boiling point are very short.

When we use that of Curie point 250° C., the rice is a little burnt at the bottom of the ceramic and the taste is sticky a little bit. The ceramic with a magnetic material using Curie point of 200° C. is the best condition for eating. The conditions of eating using the ceramic with the magnetic material are very different from that when using the quartz glass. This difference is caused by infrared and far-infrared heating of the ceramic with magnetic materials.

In the next steps, we cook beef potato. We use 100 g of beef and 300 g of a mix of potato, onion and carrot.

The microwave needs to be totally transmitted for cooking by heat-resistant glass or heat-resistant ceramic. The thermal efficiency rises by the frictions of molecules in direct microwave heating.

The infrared heating and heating vibrations of vegetable molecules are effective when using the ceramic with a magnetic material.

We proceed to the following cooking methods.

1. cooking with a heat-resistant glass; heating for 10 minutes, scrambling, heating again for 2 minutes, and the total cooking requires 12 minutes
2. cooking with a heat-resistant ceramic; heating for 10 minutes, scrambling, heating again for 2 minutes, and total cooking requires also 12 minutes.

We boil potato, carrot, onion and beef at the same time.

3. cooking ceramic with a magnetic material
3-1 ceramic with a magnetic material Curie point of 150° C.
   Potato, carrot and onion can be cooked for 7 minutes heating, beef is placed in the ceramic, heating for 3 minutes and total cooking can be done 10 minutes.
3-2 ceramic with a magnetic material Curie point of 200° C.
   potato, carrot and onion can be cooked in 6 minutes, and beef is placed in the ceramic and cooked for 3 minutes heating and total cooking can be done in 9 minutes.
3-3 ceramic with a magnetic material Curie point of 250° C.
   potato, carrot and onion can be cooked in 6 minutes and place beef in the ceramic, heating it for 3 minutes and total cooking can be done in 9 minutes.

Faster heating can be observed by black body radiation heating using magnetic material than the heating of direct microwave heating using heat-resistant ceramic and glass. The taste of potato, carrot and onion is greatly improved by far-infrared heating because the absorption wavelength of the cooking material coincides with the wavelength of far-infrared emission.

The quality of heating when using the ceramic with a magnetic material Curie point of 200° C. is softer than when using ceramic with magnetic material Curie point of 250° C.

In using different cooking methods, we compare the cooking; boiling chicken and frying fish. Cooking time does not change from one cooking methods to another for food which contains a lot of fat. However cooking time varies greatly for food which contains a lot of water.

Fish and beef with a thickness 1 to 2 cm and which have a lot of fat, we do not observe a great deviation between heating molecular friction and vibration. However there is a great difference when boiling thick piece of beef. The water is separated by direct microwave cooking of vegetables but the vegetable cooking using ceramic with magnetic material can be done in steaming condition. The water is not separated when cooking fish and chicken using ceramic with a magnetic material and the cooking can be done in the soft condition.

When we use a heat-resistant glass when heating with a microwave oven 0.5 kW during 30 minutes, the side wall of the microwave oven reaches 65° C. but when we use a ceramic with a magnetic material by heating in the microwave oven, it becomes less than 40° C. This deviation shows the thermal efficiency for heat by the effective absorption of microwave by the magnetic material. The deviation of heating between a 0.5 kW microwave oven and a 0.7 kW microwave oven is great. Faster cooking can be possible with a heat-resistant glass, a heat-resistant ceramic and a ceramic with magnetic material, when using a microwave oven with a great power. The taste of food by microwave cooking also depends on enzyme. The only time of cooking cannot influence the taste. The taste of food by infrared and far-infrared cooking is definitely judged good.

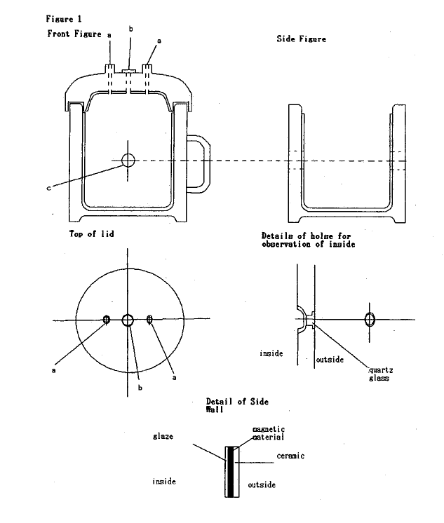

The ceramic vessel is shown in FIG. 1. It is made for the purpose of chemical synthesis, chemical bonding, metallurgy and sintering. It is a heat-resistant vessel which can forbear 1500° C. The structure is composed of a vessel and a lid. We make two holes in the vessel, one is for the irradiation of the light and the other is the structure of placing quartz to observe the temperature change and chemical reaction. We make three holes in the lid.

Two holes are used for injecting and draining of gas. The third hole is used for inserting a thermometer. The materials which are painted and sintered in the ceramic are magnetic material, magnetite, alumina, oxidized titan, oxidized chrome, zeolite, zyrconia and SiC. They are processed 5 μm to 10 μm particles and sintered in the ceramic with a thickness of 20 μm. The time at which the temperature rises by microwave irradiation is different for each material. But all materials show a high temperature rise.

We observed a temperature rise in the microwave oven 0.5 kW, 0.7 kW and 1 kW. The larger the power of the microwave oven we use, the higher temperature rise we observe. We can observe a high temperature rise with all materials as shown in equation (7). We observe following materials temperature rise by microwave irradiation 0.5 kW, 0.7 kW and 1 kW in 180 seconds and we measure temperature by thermocouple.

| | 0.5 kW | 0.7 kW | 1 kW |
|---|---|---|---|
| the magnetic material Curie point | 189 | 195 | 198 (° C.) |
| 200° C. | | | |
| magnetite | 550 | 680 | 820 |
| alumina | 370 | 540 | 710 |
| SiC | 580 | 730 | 880 |
| oxidized titan | 340 | 490 | 620 |

The temperature of the ceramic increases in a short period of time and we can process chemical reaction, chemical synthesis, metallurgy and sintering in the ceramic. We can process nitride compound in high temperature when gas is injected, such as nitrogen or reduced oxygen condition. We used Mn—Zn ferrites made by NEOMAX Co. ltd, 3F4M,3F5,3F5B,3F5C,3F5D,3F6G,3F6K and 3F6C.

In Japan 95% of people own a microwave oven. Microwave ovens for industrial are used restaurants and convenience stores. High thermal efficiency leads to efficiency of energy. The efficiency of electric power becomes high. On average a Japanese housewife works in the kitchen 1.5 hours per day with air conditioner and fan in the same time. The ceramic in this invention is heated only inside, and thermal energy which diffuses outside the ceramic exists only inside the microwave oven. The thermal efficiency in the microwave oven becomes very high compared to other heating methods. The experiments which we proceed using this invention are for microwave ovens for family use, but big industrial microwave oven also can be used.

The kitchen of the style of this invention is convenient for the young women and elder people because easy and tasty cooking can be done in short time and new food industry can be possible by the cooking methods of this invention.

What is claimed is:

1. The methods of transforming microwave to infrared and far-infrared wave and heating materials;
irradiation of microwave to the ceramic wherein magnetic material, magnetite, zyrconia, SiC, oxidized chrome, oxidized titan, zeolite, alumina that are processed particles and sintered in layer and transform microwave to infrared and far-infrared waves beyond the intensity of blackbody radiation by increasing the permeability in magnetic material and magnetite and increasing permittivity in zyrconia, SiC, oxidized chrome, oxidized titan and alumina and heating material, in said heating material choosing optimal materials sintered in said ceramic to amplify the intensity of radiation of said infrared and far-infrared waves beyond the intensity of blackbody radiation in optimal wavelengths of absorption of heating material in the optimal temperature of heating and rising the thermal efficiency.

2. The method of heating in the ceramic claimed in claim 1 in the conditions of reduced pressure or reduced oxygen in said ceramic.

3. The method of heating in the ceramic claimed in claim 1 in the condition injecting gas and nitrogen gas into said ceramic.

4. The method of cooking by heating the material claimed in claim 1.

5. The method of chemical synthesis, chemical reaction, metallurgy, crystallization of metal, sintering using the methods, claimed in claims 1, 2 and 3.

6. The method of radiating heat by the structure of eddy current loss with a vessel that has a concave or convex wherein the magnetic material is sintered.
